(19) United States
(12) Patent Application Publication
(10) Pub. No.: US 2007/0285729 A1
(43) Pub. Date: Dec. 13, 2007

(54) IMAGE PROCESSING APPARATUS AND IMAGE PROCESSING METHOD

(75) Inventor: Takahisa Wada, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/758,112

(22) Filed: Jun. 5, 2007

(30) Foreign Application Priority Data
Jun. 12, 2006 (JP) 2006-162916

(51) Int. Cl. H04N 1/405

(52) U.S. Cl. 358/3.15; 358/3.27

(57) ABSTRACT

An edge information detection section detects edge information corresponding to a spatial change in a pixel value in a predetermined region by using a two-dimensional first differential filter with respect to an input image signal. An edge intensity detection section detects an edge intensity by using a first threshold value with respect to the edge information detected in the predetermined region. A flatness detection section detects a degree of flatness by using a second threshold value smaller than the first threshold value with respect to the edge information detected in the predetermined region. A determination section generates a two or more valued determination signal by determining the edge information in the predetermined region from the edge intensity and the degree of flatness.

### CROSS-REFERENCE TO RELATED APPLICATIONS

This application is based upon and claims the benefit of priority from the prior Japanese Patent Application No. 2006-162916 filed on Jun. 12, 2006; the entire contents of which are incorporated herein by reference.

### BACKGROUND OF THE INVENTION

1. Field of the Invention

The present invention relates to an image processing apparatus and method for performing image processing for compression encoding of an image.

2. Description of the Related Art

In recent years, image encoding on moving images using a combination of orthogonal conversion and quantization such as MPEG, H.264 has been practiced. Image processing for such image encoding is performed on a block-by-block basis. In an image signal obtained by this image processing, therefore, large amounts of block noise, ringing noise and mosquito noise are generated when the bit rate is low.

This is because high-frequency components in the image signal are undesirably reduced or lowered in the quantization process due to high compression.

This phenomenon is a problem theoretically unavoidable in performing high compression. However, the scale of this phenomenon in encoding an image can be reduced by reducing or lowering high-frequency components in the image before encoding the image.

As a means for reducing high-frequency components in an image, a means of performing a convolutional operation with a filter or the like is well known. However, if the means for reducing high-frequency components is applied to the entire image, an edge portion of the resulting image is blurred.

It is, therefore, desirable to perform a convolutional operation with a filter or the like by removing edge portions of an image, typically visually conspicuous edges such as characters and area boundaries.

The execution of the convolutional operation requires detecting a visually conspicuous edge and a visually inconspicuous edge requiring, though inconspicuous, a large amount of information in encoding if not suppressed, while discriminating from each other. A method is conventionally adopted in which a Prewitt filter, a Sobel filter or the like is used for edge detection and the result of comparison between the output from the filter and a threshold value is used for determination of an edge.

The method using a Prewitt filter enables extraction of an edge portion visually conspicuous, that is, having a substantial influence on the image quality, but entails a possibility of detection of even an edge visually inconspicuous, that is, having no considerable influence on the image quality when it is lowered.

It is thought that this inconvenience can be reduced by controlling the threshold value. Even in such a case, however, it is difficult for control of only one threshold value to respond to a change in a scene on an image, and there is a strong possibility of a degradation in image quality after compression encoding.

It is desirable that an edge detection means suitable for high-compression encoding should determine two kinds of edges described below.

An edge portion, such as an edge of a character portion, an edge appearing at a portion flat on the periphery, or a boundary edge of a large region, is visually sharply recognizable and liable to influence the image quality. It is preferable to avoid filtering such a visually recognizable edge, i.e., a conspicuous edge, or to filter it only weakly. Further, at the time of compression, the compression rate is set to a lower value to improve the image quality, although the code amount is increased.

On the other hand, edges to be lowered for compression encoding are such as those in a complicated pattern portion (not high in intensity). Portions of a pattern in such edge portions are blurred by compression encoding. Also, the influence of such a complicated pattern on the image quality is not large since it is not visually sharply recognizable.

For this reason, lowering or suppressing high-frequency components of such edge portions by filtering before compression coding is effective in enabling high-compression encoding and in preventing a degradation in image quality.

Japanese Patent Laid-Open No. 10-191326 as a related art discloses an apparatus in which a horizontal edge signal and a vertical edge signal are detected by horizontal edge and vertical edge detection means to enable control of smoothing processing, whereby ringing noise at the time of decoding of an encoded image is reduced.

This related art achieves an improvement in image quality at the time of decoding and does not prevent a reduction in image equality in performing compression encoding. Also, this related art only sets one threshold value with respect to one direction and has difficulty in suitably determining edges to be discriminated, as in the case of the above-described conventional art.

### SUMMARY OF THE INVENTION

An image processing apparatus according to one embodiment of the present invention has an edge information detection section configured to detect edge information corresponding to a spatial change in a pixel value in a predetermined region by using a two-dimensional first differential filter with respect to an input image signal, an edge intensity detection section configured to detect an edge intensity by using a first threshold value with respect to the edge information detected in the predetermined region, a flatness detection section configured to detect a degree of flatness by using a second threshold value smaller than the first threshold value with respect to the edge information detected in the predetermined region, and a determination section configured to generate a two or more valued determination signal by determining the edge information in the predetermined region from the edge intensity and the degree of flatness.

An image processing method according to one embodiment of the present invention includes detecting edge information corresponding to a spatial change in a pixel value in a predetermined region by using a two-dimensional first differential filter with respect to an input image signal, detecting an edge intensity by using a first threshold value with respect to the edge information detected in the predetermined region, detecting information on flatness by using a second threshold value smaller than the first threshold value with respect to the edge information detected in the predetermined region, and outputting a two or more valued determination signal by determining the edge information in the predetermined region from the detected edge intensity and the degree of flatness.

### BRIEF DESCRIPTION OF THE DRAWINGS

FIG. 1 is a block diagram showing the configuration of an image processing apparatus according to one embodiment of the present invention;

FIGS. 2A and 2B are diagrams showing filters used for detecting horizontal and vertical edges with a convolutional operation circuit;

FIGS. 3A to 3F are diagrams for explaining computation of first edge information and second edge information with respect to an example of an image shown in FIG. 3A;

FIG. 4 is a diagram for explaining computation of the edge intensity and the degree of flatness for the first edge information and the second edge information;

FIG. 5 is a diagram showing an example of characteristics of a low-pass filter whose transmittance in a high-frequency range is limited according to the value of a filter coefficient;

FIG. 6 is a flowchart showing the procedure of processing in an image processing method according to one embodiment of the present invention;

FIGS. 7A and 7B are diagrams showing an example of edge determination data generated with respect to each region by an edge determination circuit;

FIG. 8 is a flowchart showing the procedure of processing according to a method in which filtering and image encoding processing are preformed by using a filter coefficient according to the value of edge determination data; and

FIG. 9 is a diagram showing an image and regions for explaining the operation.

### DETAILED DESCRIPTION OF THE EMBODIMENTS OF THE INVENTION

An embodiment of the present invention will be described with reference to the accompanying drawings.

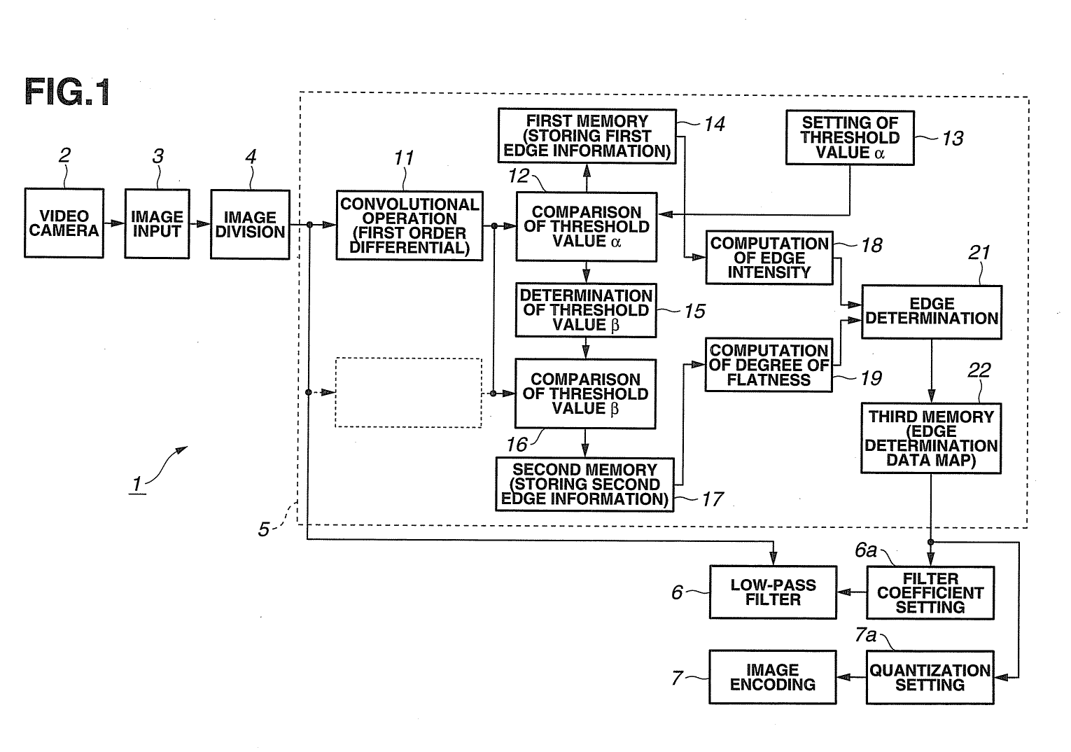

FIG. 1 shows an image processing apparatus 1 according to a first embodiment of the present invention. The image processing apparatus 1 has an image input circuit 3 to which an image signal for a moving image is input, for example, from a video camera 2 constituting a moving image generation apparatus.

The image input circuit 3 performs analog to digital (A/D) conversion with an A/D converter to convert the input image signal into a digital image signal, and outputs the digital image signal to an image division circuit 4.

The image division circuit 4 divides the input digital image signal into predetermined regions, e.g., m×n regions having dimensions: m and n numbers of pixels in horizontal and vertical directions, and outputs image signals in the divided predetermined regions to a preprocessing circuit 5 and a low-pass filter circuit 6.

The preprocessing circuit 5 performs processing including detection of edge information on the image signals in the predetermined regions, computes edge feature amounts in the regions and outputs the edge feature amounts to a filter coefficient setting circuit 6a which determines filter characteristics of the low-pass filter circuit 6.

The low-pass filter circuit 6 performs filtering processing for changing low-pass filter characteristics with respect to the image signal input from the image division circuit 4 according to the edge feature amounts obtained by the preprocessing circuit 5. That is, the preprocessing circuit 5 performs computation of edge feature amounts as preprocessing of the filtering processing performed by the low-pass filter circuit 6.

The image signal that has undergone filtering processing performed by the low-pass filter circuit 6 is input to an image encoding circuit 7 configured in accordance with MPEG2, MPEG4, H.264 or the like. The image encoding circuit 7 performs compression encoding on the input image signal.

Description will next be made of the preprocessing circuit 5.

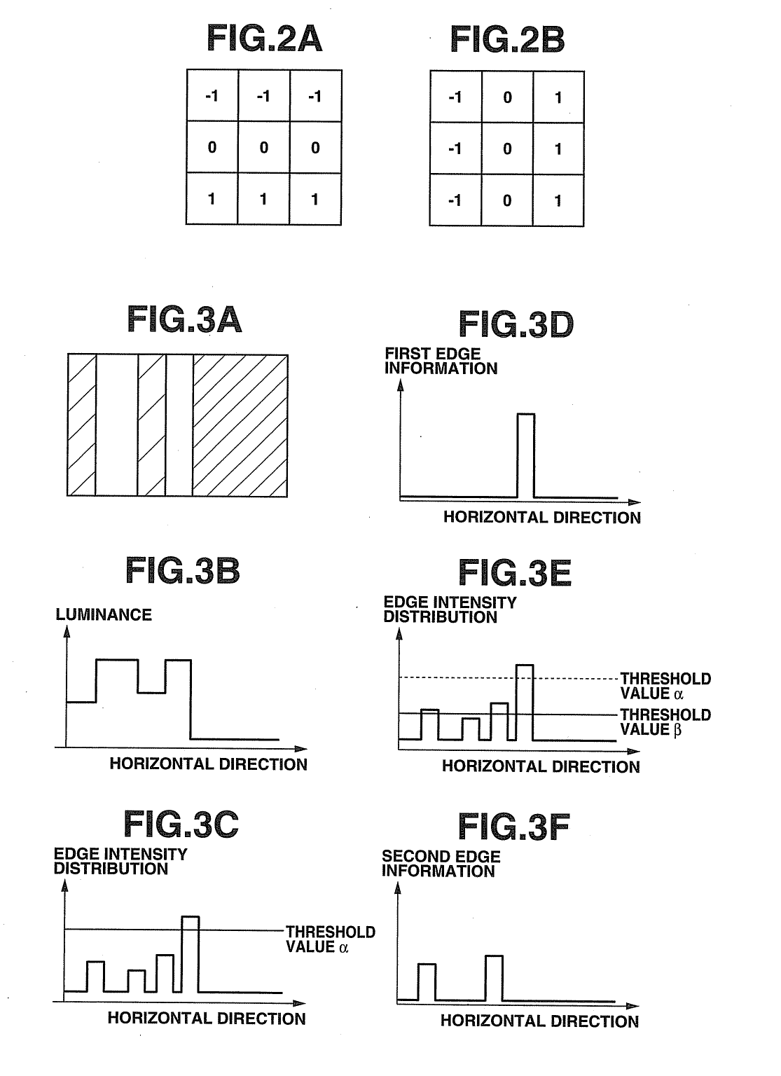

The image signal is input to a convolutional operation circuit (linear differential circuit) 11 provided as an edge information detection means. The convolutional operation circuit 11 uses first differential filters (Prewitt filters) for detection of horizontal and vertical edges, as shown in FIGS. 2A and 2B for example, to perform two-dimensional linear differential processing (differential operation processing).

Edge information is computed by the convolutional operation circuit 11, for example, as schematically shown in FIG. 3C. FIG. 3A shows an image of a region; FIG. 3B shows the luminance in the region at positions in the horizontal direction, for example; and FIG. 3C shows an edge intensity distribution with respect to the positions in the horizontal direction, i.e., edge information, computed (detected) from the image signal having this luminance by the convolutional operation circuit 11.

The edge intensity distribution signal output from the convolutional operation circuit 11 is input to a comparison circuit 12 with a threshold value α (provided as a first threshold value) for detecting an edge intensity due to a large edge. The value of the threshold value α can be set from a threshold α setting circuit 13 by a user for example.

The comparison circuit 12 compares the input signal and the threshold value α to detect an edge of a value larger than the threshold value α. If the threshold value α is set as shown in FIG. 3C, the comparison circuit 12 detects (extracts) an edge of a value larger than the threshold value α as shown in FIG. 3D, and outputs first edge information on the detected edge.

The first edge information detected by the comparison circuit 12 is held (stored) in a first memory 14. The detection result thus obtained as the first edge information indicating an edge of a value larger than the threshold value α in the region is sent to a threshold β determination circuit 15, in which a threshold value β is determined (set) as a second threshold value smaller than the threshold value α.

In the threshold β determination circuit 15, determination is made, for example, by β=α×a(0<a<1). The threshold value p determined by the threshold β determination circuit 15 is sent to a threshold β comparison circuit 16.

While threshold value a is a value for detecting a large edge in a region, the threshold value β is for detecting a small edge in the region, in other words, the degree of flatness in the region (around a large edge). In the case of determination by β=α×a shown above, therefore, the coefficient a is set, for example, to a=0.5 or less in a default state. This coefficient 37 a” may be set by a user.

The threshold β comparison circuit 16 compares the threshold value β with the output signal from the convolutional operation circuit 11 (as does the threshold α comparison circuit 12) to detect (extract) second edge information corresponding to a small edge of a value exceeding the threshold value β.

Two convolutional operation circuits 11 may be used as indicated by the broken line in FIG. 1 to perform the convolutional operation.

The threshold value β is set below the threshold value α as shown in FIG. 3E, and the comparison circuit 16 detects second edge information by this threshold value β, as shown in FIG. 3F.

The second edge information detected by the threshold β comparison circuit 16 is held (stored) in a second memory 17.

The threshold β comparison circuit 16 excludes the first edge information exceeding the threshold value α from the threshold α comparison circuit 12 or the information in the first memory 14. In this case, the first edge information exceeding the threshold value α may be excluded when the second edge information is held in the second memory 17. The threshold β comparison circuit 16 may be replaced with a circuit for detecting an edge satisfying a condition in which the value of the edge is smaller than the threshold value α and exceeding the threshold value β as the second edge information.

In FIGS. 3B to 3F, a situation in which the first edge information and the second edge information are detected with respect to the horizontal direction is illustrated by way of example for convenience sake. However, the convolutional operation circuit 11 and the other circuits detect two-dimensional edge information with respect to the vertical and horizontal directions.

The first edge information on the region stored in the first memory 14 is input to an edge intensity computation circuit 18, while the second edge information on the region stored in the second memory 17 is input to the flatness degree computation circuit 19.

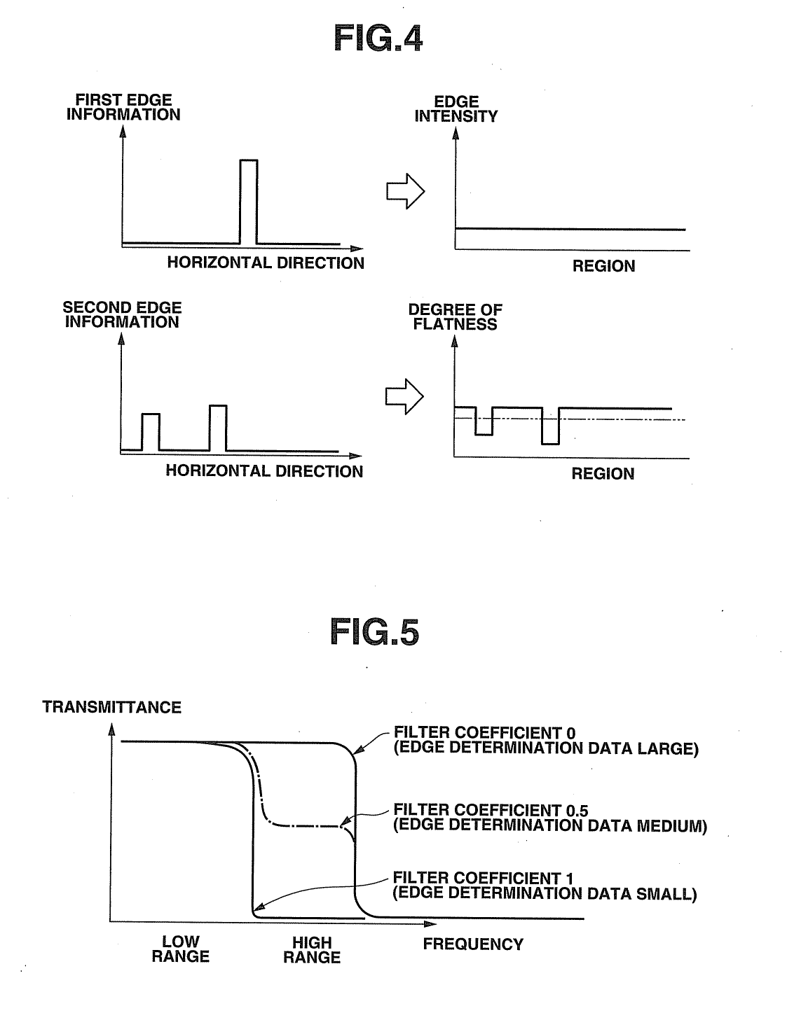

The edge intensity computation circuit 18 detects an integral value obtained by integrating the first edge information shown on the left-hand side in FIG. 4, a value proportional to the integral value, or the like. The edge intensity computation circuit 18 computes edge information on the edge intensity in the region from the detected value, as shown on the right-hand side in FIG. 4.

The flatness degree computation circuit 19 computes the degree of flatness in the region, for example, by inverting the second edge information shown on the left-hand side of FIG. 4, as shown on the right-hand side in FIG. 4.

As an alternative to the inversion for the degree of flatness indicated by the solid line in FIG. 4, information obtained by integrating or averaging (as indicated by the double-dot-dash line in FIG. 4) the inversion may be provided as information on the degree of flatness. Also, a value obtained by multiplying the computed value by a coefficient may be set as the degree of flatness.

The information on the edge intensity and the degree of flatness in each region computed by the edge intensity computation circuit 18 and the flatness degree computation circuit 19 is input to an edge determination circuit 21 shown in FIG. 1.

The edge determination circuit 21 makes a determination from the information on the edge intensity and the degree of flatness as to whether or not the edge information about the region includes any conspicuous edge or an edge to be suppressed for compression encoding, and generates, as a determination signal, edge determination data according to the edge intensity and the degree of flatness. The edge determination data or the determination signal is generated so as to be at least two-valued.

The edge determination data generated (computed) by the edge determination circuit 21 is held in a third memory 22.

In the third memory 22, edge determination data computed with respect to each region by the edge determination circuit 21 is held.

The third memory 22 outputs the held edge determination data to a filter coefficient setting circuit 6a to enable variable setting of a filter coefficient by the edge determination data.

The edge determination data has a value which tends to increase with the increase in the edge intensity and also tends to increase with the increase in degree of flatness.

If the value of this edge determination data is increased, the amount of filtering by the low-pass filter circuit 6 is reduced. Filtering when the amount of filtering is zero is the same as (equivalent to) bypassing the low-pass filter circuit 6. For example, in this case, the filter coefficient is set to zero.

When the amount of filtering is increased (that is, the filter coefficient becomes larger), the low-pass filter circuit 6 suppresses high-frequency components (high-range components) more effectively in its functioning and, therefore, has an increased tendency to pass only the signal on the low-frequency component (low-range component) side.

FIG. 5 schematically shows a state in which the value of the filter coefficient is changed and set according to the edge determination data and a state in which the low-pass filter characteristics of the low-pass filter circuit 6 are changed. In FIG.5, the filter coefficient is shown in a state of being normalized in the magnitude from 0 to 1 (more specifically, a case where the filter coefficient is set to 0, 0.5 and 1 is schematically shown).

The image encoding circuit 7 performs compression encoding on the image signal passed through the low-pass filter 6. A quantization setting circuit 7a shown in FIG. 1 will be described later in this specification.

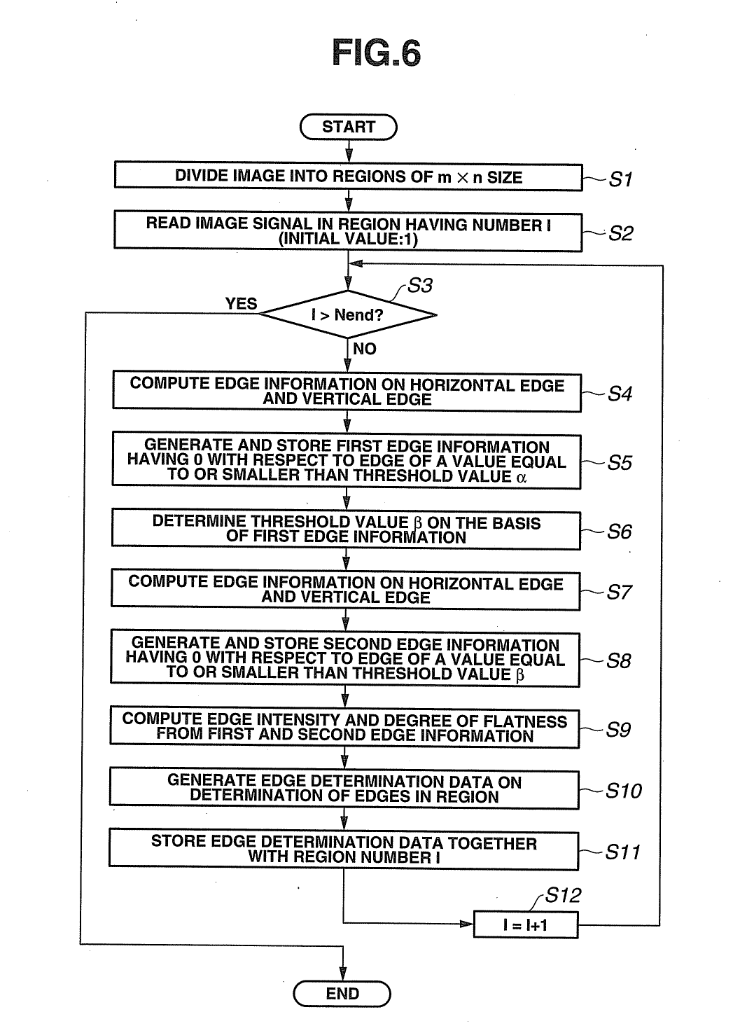

An image processing method using the image processing apparatus 1 according to the present embodiment will now be described with reference to FIG. 6.

When the image processing apparatus 1 is set in an operating condition to start operating, an image signal for a moving image taken by the video camera 2 is input to the image input circuit 3. The digital image signal obtained by A/D conversion in the image input circuit 3 is input to the image division circuit 4.

The image division circuit 4 has a buffer memory such as a frame memory and stores a portion of the input digital image signal (image data) corresponding to one frame for example.

As shown in the first step S1 in FIG. 6, the image division circuit 4 divides the image data stored in the buffer memory into predetermined regions (blocks) in an m×n size for example. The number of divided regions is assumed to be Nend and the number for each region is represented by I(I=1 to Nend).

In step S2, the convolutional operation circuit 11 in the preprocessing circuit 5 successively read the image data, for example, from that in the region indicated by the initial value 1 of the number I.

In step S3, the convolutional operation circuit 11 makes a determination as to whether or not the number I is larger than the number Nend for the final region. If this determination condition is not satisfied, the convolutional operation circuit 11 detects, in step S4, horizontal edges and vertical edges as edge information from the image data on the number I region by using the filters shown in FIGS. 2A and 2B.

The edge information detected by the convolutional operation circuit 11 is input to the threshold a comparison circuit 12. In step S5, the threshold a comparison circuit 12 compares the edge information with the threshold value α and sets the values of edge information portions of a value equal to or smaller than the threshold value a to zero.

The threshold α comparison circuit 12 generates the first edge information by performing comparison processing on the edge information as described above (see FIG. 3D). The first edge information is held in the first memory 14.

The threshold value a may be empirically determined or may be determined according to the value of the quantization scale at the time of compression encoding performed by the image encoding circuit 7.

However, since the threshold value α is a value for detection of large edge portions and computation of the intensity of the large edge portions, it is set to a large value.

In step S6, the threshold β determination circuit 15 determines, from the first edge information held in the first memory 14 (i.e., the results of detection of horizontal and vertical edges by the threshold value α), the threshold value β for obtaining the degree of flatness. Since the threshold value β is a value for obtaining the degree of flatness, it is set to a small value. It is set so as to satisfy at least a condition: β<α.

In the following step S7, the convolutional operation circuit 11 detects horizontal and vertical edges as edge information by using the filters shown in FIGS. 2A and 2B (as described above with respect to step S4).

The edge information detected by the convolutional operation circuit 11 is input to the threshold β comparison circuit 16. In step S8, the threshold β comparison circuit 16 compares the edge information with the threshold value β and sets the values of edge information portions of a value equal to or smaller than the threshold value β to zero.

The threshold β comparison circuit 16 generates the second edge information by performing comparison processing on the edge information as described above (see FIG. 3F). The second edge information is held in the second memory 17.

In the following step S9, the edge intensity computation circuit 18 and the flatness degree computation circuit 19 compute the edge intensity and the degree of flatness from the first edge information and the second edge information and output the results of computation to the edge determination circuit 21.

In the following step S10, the edge determination circuit 21 determines the existence/nonexistence of information on any visually conspicuous edge and information on other edges in the region, and generates edge determination data on the results of determination made by converting them into numeric values.

The edge determination circuit 21 generates edge determination data for making a filter coefficient setting as described above with reference to FIG. 5.

A simple example of generation of edge determination data on such a tendency is as described below. If the edge intensity is le and the degree of flatness is F, edge determination data De is generated by addition of Ie and F, i.e., De=b·Ie+c·F, where b and c are weighting coefficients.

Another simple example is conceivable in which edge determination data is generated by De=d·Ie·F. In this case, edge determination data of a larger value may be generated when the edge intensity in the case of detection of the first edge information exceeding at least the threshold value a and a certain degree of flatness are detected.

A combination of these two cases: the addition and the multiplication may be used. Thus, edge determination data of a larger value is generated with respect to a conspicuous edge portion, while edge determination data of a smaller value is generated with respect to an inconspicuous edge portion.

In the present embodiment, two different threshold values α and 62 are simultaneously used to generate edge determination data items of different values more suitably in correspondence with a conspicuous edge portion and an inconspicuous edge portion in comparison with the conventional art. Each of the threshold values α and β may be set to a common value with respect to the horizontal and vertical directions or may be set to different values with respect to the horizontal and vertical directions according to user's preference for example.

In step S11, the edge determination data is held as an edge determination data map in the third memory 22 for storing edge determination data corresponding to the region number I.

In step S12, the region number I is incremented by one. Thereafter, the processing from step S3 to step S12 is repeated. After the same processing has been performed to the region having the final number Nend, the processing shown in FIG. 6 ends.

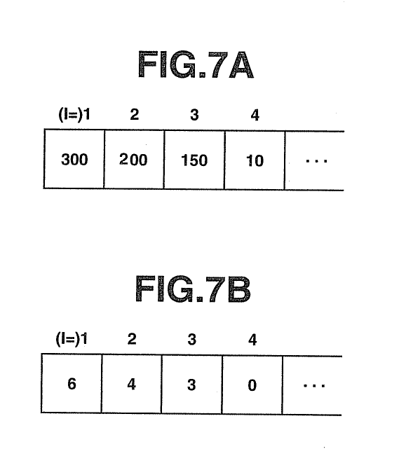

FIGS. 7A and 7B show a schematic example of edge determination data stored in the third memory 22. FIG. 7A shows an example in which edge determination data generated by the edge determination circuit 21 is held without being changed.

A method of holding edge determination data other than holding data as shown in FIG. 7A may alternatively be used in which, as shown in FIG. 7B, edge determination data is quantized by a suitable value such that the amount of information thereof is reduced, and the quantized data is held in the third memory 22.

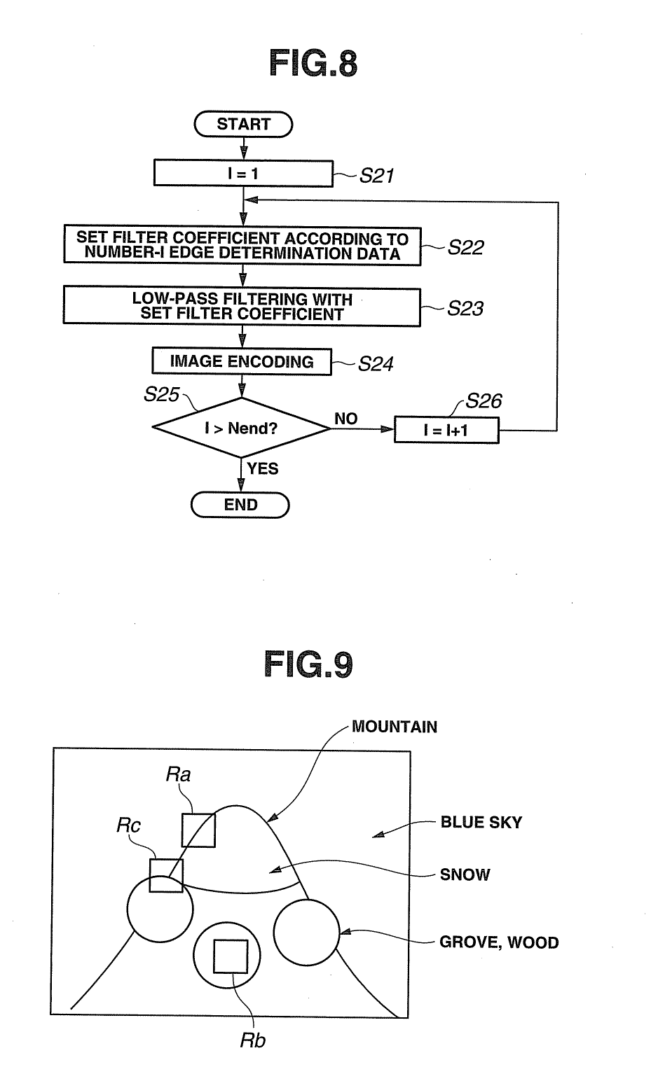

The method shown in FIG. 6 corresponds to contents of the processing in the preprocessing circuit 5 shown in FIG. 1. When edge determination data corresponding to one frame for example is held in the third memory 22, the image signal for the frame (image data) in which the edge determination data has been held is input to the image encoding circuit 7 via the low-pass filter circuit 6. Filtering processing and image encoding processing are thereafter performed, as shown in FIG. 8.

In the first step S21, the region number is set to the initial value 1. In the next step S22, the filter coefficient setting circuit 6a reads the number I edge determination data from the third memory 22 and sets the filter coefficient according to the value of the edge determination data.

In the subsequent step S23, the low-pass filter circuit 6 performs low-pass filtering on the image signal for the number I region by using the filter coefficient corresponding to the value of the edge determination data.

If the image signal output from the low-pass filter circuit 6 includes many visually conspicuous edge portions, the amount of filtering is small, that is, information on the high-range side is not substantially reduced. In contrast, if there are few conspicuous edge portions, the amount of filtering is large, that is, information on the high-range side is substantially reduced.

In the subsequent step S24, the image encoding circuit 7 performs, on the image signal output from the low-pass filter circuit 6, image encoding in such a manner that the amount of information is compressed in encoding the image signal.

In step S25, the filter coefficient setting circuit 6a makes a determination as to whether or not the number I is the final number Nend. In the case of NO, the number I is incremented by one in step S26 and the process returns to step S22.

Thus, the number is incremented one by one and the processing from step S22 to step S26 is repeated. After being performed on the region having the final number Nend, this processing ends (the same processing is performed on the image signal for the next frame).

The encoded data obtained as a result of image encoding by the image encoding circuit 7 is recorded on an image recording medium.

The image recording medium is set in an image decoding apparatus (not shown) to decode the encoded data and display the decoded data on a display.

The above-described image signal is assumed to correspond to an image such as shown in FIG. 9. It is assumed that in this image a portion of a mountain closer to the mountaintop is covered with snow; the boundary between a blue sky and the mountain portion is clear; and fine patterns or structural portion such as groves or woods (roughly indicated by a circles) exist closer to the foot of the mountain.

In this case, a larger number of first edge information items are detected with respect to a region including the boundary between the mountain portion closer to the mountaintop and the blue sky indicated by Ra. Also, the degree of flatness is high in this region. Accordingly, the value of edge determination data is large. For example, this region corresponds to the region number I=1 in FIG. 7A or 7B.

Also, in this case, filtering is performed, for example, by using the filtering coefficient 0 in FIG. 5 or a value closer to this. Therefore the signal is compression-encoded while ensuring high image quality without making the boundary unclear.

On the other hand, the region indicated by Rb is a region formed of a fine pattern for a grove, a wood or the like. From this region, substantially no first edge information is detected while many second edge information items are detected, so that the degree of flatness is considerably low. Accordingly, the value of edge determination data is small. For example, this region corresponds to the region number I=4 in FIG. 7A or 7B.

In this case, filtering is performed, for example, by using the filtering coefficient 1 in FIG. 5. Thus, high-frequency components of this portion are lowered or reduced before processing which may cause a blur by compression encoding is performed, thereby avoiding the occurrence of any conspicuous blur and ensuring high compression encoding while limiting degradation in image quality.

The region indicated by Rc in FIG. 9 has a medium feature between those of the regions Ra and Rb. Accordingly, medium edge determination data results. For example, this region corresponds to the region number I=3 in FIG. 7A or 7B. In this case, compression encoding is performed with a medium characteristic between those for the regions Ra and Rb.

As can be understood from the description with reference to FIG. 9, this image processing apparatus 1 can perform image encoding (compression encoding) with good image quality by limiting filtering on conspicuous edge portions, can perform image encoding by reducing high-frequency components before image encoding with respect to inconspicuous edge portions so that the amount of information is reduced, and is capable of preventing a degradation in image quality of the encoded image.

Thus, the image processing apparatus 1 according to the embodiment of the present invention detects a large edge portion by using a first threshold value and detects a degree of flatness by using a second threshold value smaller than the first threshold value, thereby generating a determination signal for determining a visually conspicuous edge portion and a visually inconspicuous edge portion.

After controlling filtering with a filter means according to the value of the determination signal, the image processing apparatus 1 performs image encoding for image compression by the image encoding means, thus enabling image encoding with efficiency while preventing a degradation in image quality.

Thus, according to the present embodiment, edge determination suitable for compression encoding can be made on a visually conspicuous edge portion and a visually inconspicuous edge portion.

A modified example of the image processing apparatus according to the present embodiment will next be described.

In the preprocessing circuit 5 according to the modified example in FIG. 1, each of the threshold α comparison circuit 12 and the threshold β comparison circuit 16 performs comparison using a plurality of different values. Correspondingly, the edge intensity computation circuit 18 and the flatness degree computation circuit 19 compute a plurality of edge intensities and a plurality of degrees of flatness.

Further, the edge determination circuit 21 generates a plurality of edge determination data items. The plurality of edge determination data items can be used for filter coefficient setting and for control of the quantization setting circuit 7a for setting a quantization value in the image encoding circuit 7.

That is, the quantization setting circuit 7a changes the quantization value according to the edge determination data obtained by the edge determination circuit 21 to enable image encoding at different compression rates.

This arrangement has the advantage of increasing choices in compression encoding.

The preprocessing circuit 5 according to the present embodiment is also capable of finely adjusting the edge detection threshold value by using the quantization scale at the time of encoding, thereby enabling application even to a case where ringing noise correction is performed according to the quality of an image to be encoded.

A method may be adopted in which a plurality of kinds of images to be used as a reference are prepared in advance; the filter coefficient is changed and set according to edge determination data obtained by changing threshold values α and β with respect to each image; and the threshold values α, and β in a case where images compressed with suitable image quality are generated are held.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image processing apparatus comprising:
an edge information detection section configured to detect edge information corresponding to a special change in a pixel value in a predetermined region by using a two-dimensional first differential filter with respect to an input image signal;
an edge intensity detection section configured to detect an edge intensity by using a first threshold value with respect to the edge information detected in the predetermined region;
a flatness detection section configured to detect a degree of flatness by using a second threshold value smaller than the first threshold value with respect to the edge information detected in the predetermined region; and
a determination section configured to generate a two or more valued determination signal by determining the edge information in the predetermined region from the edge intensity and the degree of flatness.

2. The image processing apparatus according to claim 1, wherein the edge intensity detection section detects as the edge intensity a value proportional to an integral value of the edge information exceeding the first threshold value.

3. The image processing apparatus according to claim 1, wherein the flatness detection section detects as the degree of flatness a value obtained by inverting the edge information equal to or smaller than the first threshold value and exceeding the second threshold value, or a value proportional to an integral of the inverted value.

4. The image processing apparatus according to claim 1, wherein the determination section outputs as the determination signal the product of the edge intensity and the degree of flatness or the sum of weighted values of the edge intensity and the degree of flatness.

5. The image processing apparatus according to claim 1, further comprising a filter section configured to perform filtering using a filter coefficient for variably setting the amount of filtering on the image signal, the filter coefficient being changed and set according to the value of the determination signal.

6. The image processing apparatus according to claim 1, wherein the determination section generates the determination signal so that the larger the edge intensity or the degree of flatness is, the smaller the filtering performed by the filter section to suppress high frequency components is.

7. The image processing apparatus according to claim 1, wherein the determination section generates a two or more valued determination signal with respect to information on a visually conspicuous edge according to a combination of the edge intensity information and the information on the degree of flatness.

8. The image processing apparatus according to claim 1, further comprising an image division circuit configured to divide each frame or field of a moving image into a plurality of the predetermined regions of a predetermined pixel number size in horizontal and vertical directions, and output image signals for the plurality of the divided predetermined regions as the image signal to the edge information detection section.

9. The image processing apparatus according to claim 8, wherein a determination value determined by the determination section is stored in a storage circuit by being associated with the predetermined region from which the edge information is detected.

10. The image processing apparatus according to claim 5, further comprising an encoding section configured to perform encoding on the image signal filtered by the filter section.

11. The image processing apparatus according to claim 5, further comprising an encoding section configured to perform compression encoding on the image signal filtered by the filter section, the determination signal being used for setting a value for quantization when compression encoding is performed.

12. The image processing apparatus according to claim 1, further comprising a threshold value setting circuit configured to variably set at least one of the first threshold value and the second threshold value.

13. An image processing method comprising:
detecting edge information corresponding to a spatial change in a pixel value in a predetermined region by using a two-dimensional first differential filter with respect to an input image signal;
detecting an edge intensity by using a first threshold value with respect to the edge information detected in the predetermined region;
detecting information on flatness by using a second threshold value smaller than the first threshold value with respect to the edge information detected in the predetermined region; and
outputting a two or more valued determination signal by determining the edge information in the predetermined region from the detected information on the edge intensity and the flatness.

14. The image processing method according to claim 13, wherein the processing to detect the edge intensity by using the first threshold value with respect to the edge information detected in the predetermined region is processing to detect as the edge intensity a value proportional to an integral value of the edge information exceeding the first threshold value.

15. The image processing method according to claim 13, wherein the processing to detect information on flatness by using a second threshold value smaller than the first threshold value with respect to the edge information detected in the predetermined region is processing to detect as the degree of the flatness a value obtained by inverting the edge information equal to or smaller than the first threshold value and exceeding the second threshold value, or a value proportional to the average of the inverted value.

16. The image processing method according to claim 13, wherein filtering using a filter coefficient for variably setting the amount of filtering on the image signal is performed, the filter coefficient being changed and set according to the value of the determination signal.

17. The image processing method according to claim 16, wherein the determination signal is generated so that the larger the edge intensity is or the degree of flatness is, the smaller the filtering to suppress high frequency components is.

18. The image processing method according to claim 13, wherein the input image signal is divided into a plurality of predetermined regions, and edge information according to two-dimensional changes in pixel values in each of the predetermined regions by using the two-dimensional first differential filter is thereafter detected.

19. The image processing method according to claim 18, wherein the determination signal determining the edge information is stored by being associated with the predetermined region used for determination.

20. The image processing method according to claim 16, wherein encoding is performed on the image signal having been processed by the filtering.
